(19) United States
(12) Patent Application Publication
(10) Pub. No.: US 2011/0113208 A1
(43) Pub. Date: May 12, 2011

(54) STORING CHECKPOINT DATA IN NON-VOLATILE MEMORY

(76) Inventors: Norman Paul Jouppi, Palo Alto, CA (US); Alan Lynn Davis, Coalville, UT (US); Nidhi Aggarwal, Sunnyvale, CA (US); Richard Kaufmann, San Diego, CA (US)

(21) Appl. No.: 12/989,981

(22) PCT Filed: May 1, 2008
(86) PCT No.: PCT/US08/62154

§ 371 Date: Jan. 14, 2011

(51) Int. Cl. G06F 12/16; G06F 13/00

(52) U.S. Cl. 711/162; 711/E12.103

(57) ABSTRACT

Methods and systems for storing checkpoint data in non-volatile memory are described. According to one embodiment, a data storage method includes executing an application using processing circuitry and during the execution, writing data generated by the execution of the application to volatile memory. An indication of a checkpoint is provided after writing the data. After the indication has been provided, the method includes copying the data from the volatile memory to non-volatile memory and, after the copying, continuing the execution of the application. The method may include suspending execution of the application. According to another embodiment, a data storage method includes receiving an indication of a checkpoint associated with execution of one or more applications and, responsive to the receipt, initiating copying of data resulting from execution of the one or more applications from volatile memory to non-volatile memory. In some embodiments, the non-volatile memory may be solid-state non-volatile memory.

### FIELD OF THE DISCLOSURE

Aspects of the disclosure relate to storing checkpoint data in non-volatile memory.

### BACKGROUND OF THE DISCLOSURE

As semiconductor fabrication technology continues to scale to ever-smaller feature sizes, fault rates of hardware are expected to increase. At least two types of failures are possible: transient errors, which may be temporary but may persist for a small amount of time; and hard errors, which may be permanent. Transient errors may have many causes. Example transient errors include transistor faults due to power fluctuations, thermal effects, alpha particle strikes, and wire faults that result from interference due to cross-talk, environmental noise, and/or signal integrity problems. Hard error causes include, for example, transistor failures caused by a combination of process variations and excessive heat and wire failures due to fabrication flaws or metal migration caused by exceeding a critical current density of the wire material.

Both hard and transient errors may be internally corrected using redundancy mechanisms at either fine or large levels of granularity. Fine grain mechanisms include error correcting codes in memory components, cyclic redundancy codes on packet transmission channels, and erasure coding schemes in disk systems. Large grain mechanisms include configuring multiple processors to execute the same instructions and then comparing the execution results from the multiple processors to determine the correct result. In such cases, the number of processors executing the same instructions should be two or more in order to detect an error. If the number of processors is two, errors may be detected. If the number of processors is three or more, errors may be both detected and corrected. Using such redundancy mechanisms, however, may be prohibitively expensive for large-scale parallel systems.

Large-scale parallel systems may include clusters of processors that execute a single long-running application. In some cases, large-scale parallel systems may include millions of integrated circuits that execute the single long-running application for days or weeks. These large-scale parallel systems may periodically checkpoint the application by storing an intermediate state of the application on one or more disks. In the event of a fault, the computation may be rolled back and restarted from the most recently recorded checkpoint instead of the beginning of the computation, potentially saving hours or days of computation time.

Consequently, the use of checkpointing in at least some computing arrangement (e.g., large-scale parallel systems) may become increasingly important as feature sizes of semiconductor fabrication technology decrease and fault rates increase. Known systems write checkpoint data to disks. However, disk bandwidths and disk access times might not improve quickly enough to keep up with demands of the computing system. Furthermore, the amount of power consumed in checkpointing data using mechanical media such as disks is a significant drawback.

### SUMMARY

According to some aspects of the disclosure, methods and systems for storing checkpoint data in non-volatile memory are described.

According to one aspect, a data storage method includes executing an application using processing circuitry and during the execution, writing data generated by the execution of the application to volatile memory. The method also includes providing an indication of a checkpoint (e.g., an indication of checkpoint completion) after writing the data to volatile memory. After the indication of the checkpoint has been provided, the method includes copying the data from the volatile memory to non-volatile memory and, after the copying, continuing the execution of the application. In some embodiments, the non-volatile memory may be solid-state memory and/or random access memory.

Subsequent to the continuing of the execution, the method may, in some embodiments, include detecting an error in the execution of the application. Responsive to the detection, the data is copied from the non-volatile memory to the volatile memory. Next, the application may be executed from the checkpoint using the copied data stored in the volatile memory.

According to another aspect, a data storage method includes receiving an indication of a checkpoint associated with execution of one or more applications and, responsive to the receipt, initiating copying of data resulting from execution of the one or more applications from volatile memory to non-volatile memory. In some embodiments, the indication may describe locations within the volatile memory where the data is stored.

According to another aspect, a computer system includes processing circuitry and a memory module. The processing circuitry is configured to process instructions of an application. The memory module may include volatile memory configured to store data generated by the processing circuitry during the processing of the instructions of the application. The memory module may also include non-volatile memory configured to receive the data from the volatile memory and to store the data. In one embodiment, the processing circuitry is configured to initiate copying of the data from the volatile memory to the non-volatile memory in response to a checkpoint being indicated.

In one embodiment, the non-volatile memory and the volatile memory may be organized into one or more Dual In-line Memory Modules (DIMMs) such that an individual DIMM includes all or a portion of the non-volatile memory and all or a portion of the volatile memory. In one embodiment, the non-volatile memory may include a plurality of integrated circuit chips and the copying of the data may include simultaneously copying a first subset of the data to a first one of the plurality of integrated circuit chips and copying a second subset of the data to a second one of the plurality of integrated circuit chips.

Other embodiments and aspects are described as is apparent from the following discussion.

### DESCRIPTION OF THE DRAWINGS

FIG. 1 is a block diagram of a processing system according to one embodiment.

FIG. 2 is a block diagram of a computer system according to one embodiment.

FIG. 3 is a block diagram of a memory module according to one embodiment.

FIG. 4 is a block diagram of a processing system according to one embodiment.

### DETAILED DESCRIPTION

The present disclosure is directed towards apparatus such as processing systems, computers, processors, and computer systems and methods including methods of storing checkpoint data in non-volatile memory. According to some aspects of the disclosure, an application is executed using processing circuitry. When the execution of the application reaches a checkpoint, further execution of the application may be suspended, in one embodiment. Data related to the application that is stored in volatile memory may be copied into non-volatile memory. In some embodiments, the non-volatile memory may be solid-state non-volatile memory such as NAND FLASH or phase change memory. The non-volatile memory may additionally or alternatively be random access memory.

In one embodiment, once the data has been copied, execution of the application may be resumed. If an error occurs during the execution of the application, the data stored in the non-volatile memory may be copied back into the volatile memory. Once the data has been restored to the volatile memory, the application may be restarted from the checkpoint. Other or alternative embodiments are discussed below.

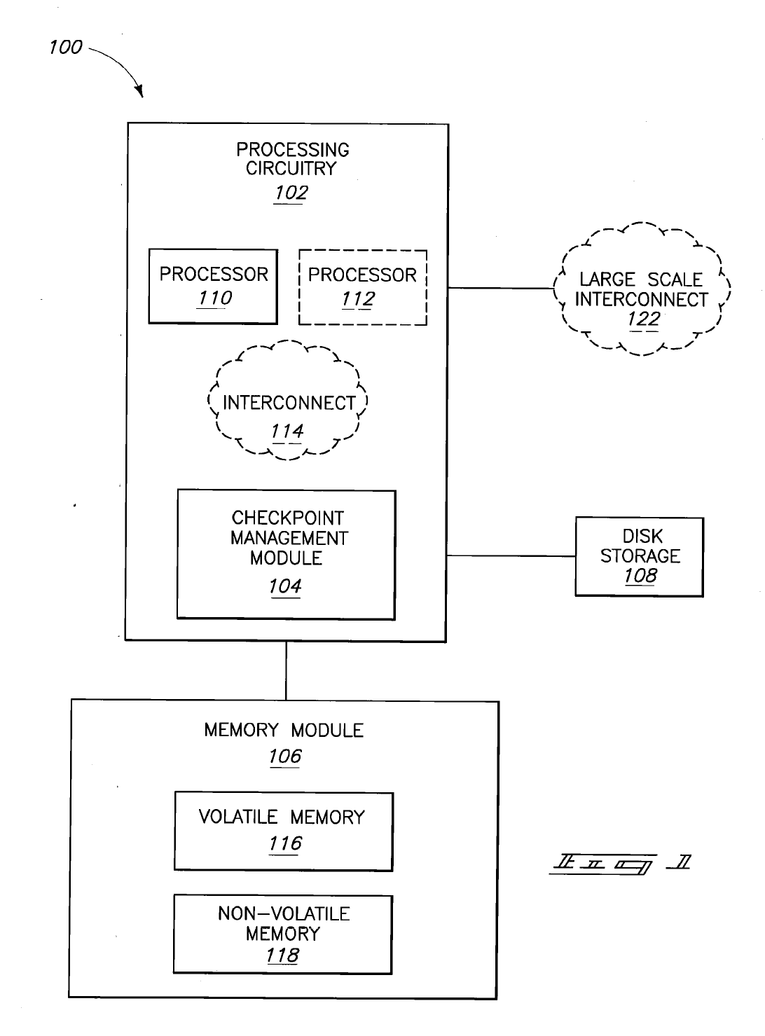

Referring to FIG. 1, a processing system 100 according to one embodiment is illustrated. System 100 includes processing circuitry 102, memory module 106, and disk storage 108. The embodiment of FIG. 1 is provided to illustrate one possible embodiment and other embodiments including less, more, or alternative components are possible. In addition, some components of FIG. 1 may be combined.

In one embodiment, system 100 may be a single computer. In this embodiment, processing circuitry 102 may include one processor 110 but might not include interconnect 114 and might not be in communication with large scale interconnect 122, both of which are shown in phantom and are described further below. In this embodiment, processor 110 may be a single core processor or a multi-core processor.

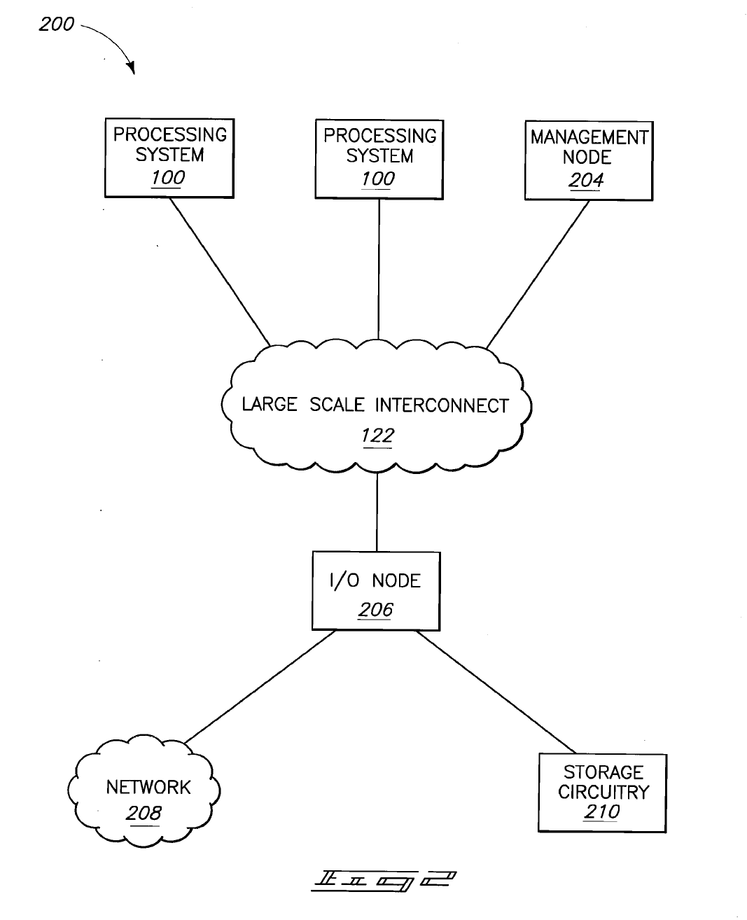

In another embodiment, system 100 may be a processor cluster. In this embodiment, processing circuitry 102 may include a plurality of processors. Although just two processors, processor 110 and processor 112, are illustrated in FIG. 1, processing circuitry 102 may include more than two processors. In some cases, the processors of processing circuitry 102 may simultaneously execute a single application. As a result, the application may be executed in parallel. In this embodiment, processing circuitry 102 may include interconnect 114 that enables communication between processors 110 and 112 and coordination of the execution of the application. Furthermore, in various embodiments, processing circuitry 102 may be in communication with other processor clusters (which may also be executing the application) via large scale interconnect 122 as will be described further below in relation to FIG. 2.

Memory module 106 includes volatile memory 116 and non-volatile memory 118 in one embodiment. Volatile memory 116 may store data generated by processing circuitry 102 and data retrieved from disk storage 108. Such data is referred to herein as application data. Volatile memory 116 may be embodied in a number of different ways using electronic, magnetic, optical, electromagnetic, or other techniques for storing information. Some specific examples include, but are not limited to, DRAM and SRAM. In one embodiment, volatile memory 116 may store programming implemented by processing circuitry 102.

Non-volatile memory 118 stores checkpoint data received from volatile memory 116. The checkpoint data may be the same as the application data or the checkpoint data may be a subset of the application data. In some embodiments, non-volatile memory 118 may persistently store the checkpoint data even though power is not provided to non-volatile memory 118. As mentioned above, application data and checkpoint data are stored in memory in one embodiment. Storage in memory includes storing the data in an integrated circuit storage medium. In one embodiment, non-volatile memory 118 may be solid-state and/or random access non-volatile memory (e.g., NAND FLASH, FeRAM (ferromagnetic RAM), MRAM (magneto-resistive RAM), PCRAM (phase change RAM), RRAM (resistive RAM), Probe Storage, and NRAM (nanotube RAM)). In one embodiment, reading the checkpoint data from non-volatile memory 118 does not use moving parts. In another embodiment, non-volatile memory 118 may be accessed in a random order. Furthermore, non-volatile memory 118 may return data in a substantially constant time, regardless of the data's physical location within non-volatile memory 118, whether or not the data is related to previously accessed data.

In one embodiment, processing circuitry 102 includes checkpoint management module 104. Checkpoint management module 104 is configured to control and implement checkpoint operations in one embodiment. For example, checkpoint management module 104 may control copying checkpoint data from volatile memory 116 to non-volatile memory 118 and copying checkpoint data from non-volatile memory 118 to volatile memory 116. Checkpoint management module 104 may include processing circuitry such as a processor, in one embodiment. In other embodiments, checkpoint management module 104 may be embodied in processor 110 and/or processor 112 (e.g., as microcode or software).

By way of example, processing circuitry 102 may execute an application stored by disk storage 108 (e.g., one or more hard disks). The application may comprise a plurality of instructions. Some or all of the instructions may be copied from disk storage 108 into volatile memory 116. Some or all of the instructions may then be transferred from volatile memory 116 to processing circuitry 102 so that processing circuitry 102 may process the instructions. As a result of processing the instructions, processing circuitry 102 may retrieve application data from volatile memory 116 or disk storage 108 and/or may write application data to volatile memory 116 or disk storage 108. Consequently, as instructions of the application are processed by processing circuitry 102, the contents of volatile memory 116 and/or disk storage 108 may change.

Some or all of the contents of volatile memory 116 at a particular point in time may be preserved as checkpoint data. For example, after processing circuitry 102 processes one or more initial instructions of the application, checkpoint data (which may be all or a subset of the application data) stored in volatile memory 116 may be copied to a location other than volatile memory 116. Once the checkpoint data has been copied, processing circuitry 102 may proceed to process one or more ensuing instructions of the application. Later, it may be determined that subsequent to processing the initial instructions, an error occurred while executing the application. To recover from the error, the stored checkpoint data may be restored to volatile memory 116 and processing circuitry 102 may restart execution of the application beginning with the ensuing instructions.

In one embodiment, checkpoint management module 104 may manage the storage of checkpoint data. In one embodiment, checkpoint management module 104 may receive an indication of a checkpoint associated with the execution of one or more applications from processing circuitry 102. Indications to perform checkpoint operations may be provided by different sources and/or for different initiating criteria as discussed below in illustrative examples. Processing circuitry 102 may provide the indication to checkpoint management module 104 after processing circuitry 102 has flushed the contents of one or more cache memories (not illustrated) of processing circuitry 102 to volatile memory 116. One or more of a variety of entities within processing circuitry 102 may provide the indication. For example, an operating system, a virtual machine, a hypervisor, or an application may generate the indication for a checkpoint. Other sources of criteria for generating the indications are possible and are discussed below.

In response to receiving the indication, checkpoint management module 104 may initiate copying all or portions of application data stored by volatile memory 116 to non-volatile memory 118. In one embodiment, prior to or subsequent to providing the indication to checkpoint management module 104, processing circuitry 102 may suspend execution of the application(s) that are being checkpointed so that the application data of the application(s) being checkpointed does not change while the checkpoint data is copied from volatile memory 116 to non-volatile memory 118.

In some embodiments, processing circuitry 102 may write application data to volatile memory 116 and non-volatile memory 118. In other embodiments, processing circuitry 102 may write application data to volatile memory 116 but might not be able to write application data to non-volatile memory 118. However, checkpoint data may be copied from volatile memory 116 to non-volatile memory 118. Thus, to write checkpoint data into non-volatile memory 118, the checkpoint data might need to be first written into volatile memory 116.

Relative capacities of volatile memory 116 and non-volatile memory 118 may be configured in any appropriate configuration. For example, since an error may occur just before completion of a checkpoint operation, in one embodiment non-volatile memory 118 may have at least twice the capacity of volatile memory 116 so that non-volatile memory 118 may store two sets of checkpoint data. In addition, numerous different checkpoint data corresponding to different checkpoints may also be simultaneously stored in non-volatile memory 118 in at least one embodiment.

A checkpoint indication may designate which portions of the application data stored by volatile memory 116 are checkpoint data. For example, the indication may indicate that substantially all of the application data stored by volatile memory 116 is checkpoint data, that application data related only to a particular application is checkpoint data, and/or that application data within particular locations of volatile memory 116 is checkpoint data. In one embodiment, the indication may include a save vector describing the checkpoint data.

In one embodiment, processing circuitry 102 may implement copying of checkpoint data from volatile memory 116 to non-volatile memory 118 by controlling volatile memory 116 and non-volatile memory 118. For example, processing circuitry 102 may provide control signals or instructions to volatile memory 116 and non-volatile memory 118. In another embodiment, checkpoint management module 104 may implement copying of the checkpoint data by controlling memories 116 and 118. Checkpoint management module 104 may inform processing circuitry 102 once the checkpoint data has been successfully copied to non-volatile memory 118.

In another embodiment, memory module 106 may include separate processing circuitry (not illustrated) and processing circuitry 102 or checkpoint management module 104 may provide information describing the checkpoint data (e.g., locations of volatile memory 116 where the checkpoint data is stored) to such processing circuitry and instruct such processing circuitry to copy the checkpoint data to non-volatile memory 118. The processing circuitry of memory module 106 may inform checkpoint management module 104 and/or processing circuitry 102 once the checkpoint data has been successfully copied to non-volatile memory 118.

After determining that the checkpoint data has been successfully copied to non-volatile memory 118, checkpoint control module 104 may inform processing circuitry 102 that the checkpoint data has been copied to non-volatile memory 118. In response, processing circuitry 102 may continue execution of the application(s) that processing circuitry 102 had previously suspended while the checkpoint data was being copied to non-volatile memory 118. System 100 may repeat the above-described method of storing checkpoint data in non-volatile memory 118 a plurality of times during execution of an application.

As mentioned above, several approaches may be used to determine when a checkpoint should be generated. According to one approach, checkpoint data may be stored periodically and may be stored for a plurality of applications being executed by processing circuitry 102. In this embodiment, processing circuitry 102 (e.g., via an operating system, virtual machine, hypervisor, etc. executed by processing circuitry 102) may periodically indicate a checkpoint to checkpoint management module 104 as was described above. The period of the checkpoint operation may be controlled by a timer interrupt or by periodic operating system intervention in some examples. In one embodiment, substantially all of the application data stored by volatile memory 116 may be copied to non-volatile memory 118. Alternatively, application data related to just one application being executed by processing circuitry 102 may be copied to non-volatile memory 118. This approach may be referred to as automatic checkpointing.

According to another approach, an application being executed by processing circuitry 102 may determine when checkpoint data should be generated. In one embodiment, the application may specify which application data should be stored as checkpoint data and when to store the checkpoint data. In one embodiment, the application may include checkpoint instructions. The checkpoint instructions may be located throughout the application so that the application is divided into sections of instructions delimited by the checkpoint instructions. In one embodiment, checkpoint instructions may be positioned at the end of a section of instructions performing a particular calculation or function. For example, if the application is a banking application that updates an account balance, the application may include a checkpoint instruction just after instructions that update the account balance. In another embodiment, the application may request that checkpoint data be generated in response to a condition being met. This approach may be referred to as application checkpointing.

Subsequent to checkpoint data being stored and execution of the application being resumed, processing circuitry 102 and/or checkpoint management module 104 may detect an error in the execution of the application (e.g., via redundant computation checks). In one embodiment, upon the detection of the error, processing circuitry 102 may suspend further execution of the application.

To recover from the error, the application may be re-executed beginning at a checkpoint associated with checkpoint data stored in non-volatile memory 118. In response to the detection of the error, checkpoint management module 104 may copy the checkpoint data from non-volatile memory 118 to volatile memory 116. Once the checkpoint data has been copied to volatile memory 116, checkpoint management module 104 may notify processing circuitry 102. Processing circuitry 102 may then re-execute the application beginning at the checkpoint using the checkpoint data, which is now available to processing circuitry 102 in volatile memory 116.

In one embodiment, the checkpoint data may be checkpoint data of a plurality of applications and the detected error may affect all of the applications of the plurality. In this embodiment, once the checkpoint data has been restored, each of the applications of the plurality may be re-executed beginning at the checkpoint.

Referring to FIG. 2, a large-scale computer system 200 is illustrated. System 200 includes plural processing systems 100 described above in relation to FIG. 1. In one embodiment, systems 100 may be used to execute a single application in parallel or different applications. Executing the single application in parallel may provide significant speed advantages over executing the single application on one processor or one processor cluster. System 200 may include additional processing systems, which are not illustrated for simplicity.

In one embodiment, system 200 also includes a management node 204, large scale interconnect 122, an I/O node 206, a network 208, and storage circuitry 210. In one embodiment, management node 204 may determine which portions of a single application are to be executed by the processing systems. Management node 204 may communicate with processing systems 100 via large scale interconnect 122.

During the execution of the application, processing system 100 and/or processing system 202 may store data in storage circuitry 210. To do so, the processing systems may send the data to storage circuitry 210 via large scale interconnect 122 and I/O node 206. Similarly, the processing systems may retrieve data from storage circuitry 210 via large scale interconnect 122 and I/O node 206. For example, processing system 100 may move data from disk storage 108 to storage circuitry 210, which may have a larger capacity than disk storage 108. In some embodiments, processing systems 100 and 202 may communicate with other computer systems via I/O node 206 and network 208. In one embodiment, network 208 may be the Internet.

In one embodiment, storage circuitry 210 may include non-volatile memory and management node 204 may initiate copying of checkpoint data from processing systems 100 to the non-volatile memory of storage circuitry 210 via large scale interconnect 122.

Returning now to FIG. 1, memory module 106 may be configured to simultaneously copy different portions of the checkpoint data stored in volatile memory 116 to non-volatile memory 118 in parallel rather than serially copying the checkpoint data. Doing so may significantly reduce an amount of time used to copy the checkpoint data from volatile memory 116 to non-volatile memory 118.

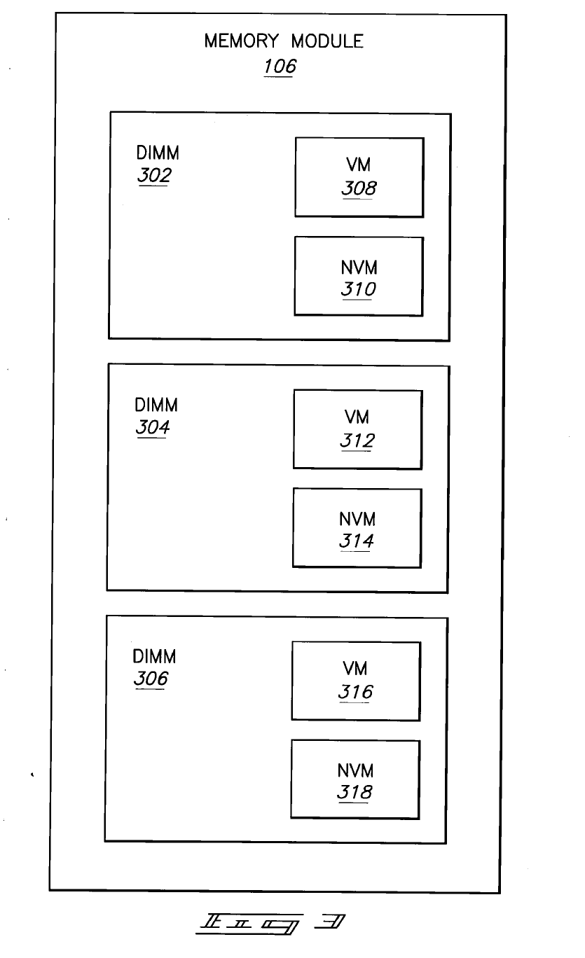

Referring to FIG. 3, one embodiment of memory module 106 is illustrated. The disclosed embodiment is merely illustrative and other embodiments are possible. In the depicted embodiment, memory module 106 includes three dual in-line memory modules (DIMMs) 302, 304, and 306. Of course, memory module 106 may include fewer than three or more than three DIMMs, three DIMMs are illustrated for simplicity. Alternatively or additionally, memory module 106 may include other forms of memory apart from DIMMS.

Each of DIMMs 302, 304, and 306 may include a portion of volatile memory 116 and a portion of non-volatile memory 118. As illustrated in FIG. 3, DIMM 302 includes volatile memory (VM) 308 and non-volatile memory (NVM) 310, DIMM 304 includes volatile memory (VM) 312 and non-volatile memory (NVM) 314, and DIMM 306 includes volatile memory (VM) 316 and non-volatile memory (NVM) 318. Volatile memories 308, 312, and 316 may each be a different portion of volatile memory 116 of FIG. 1. Similarly, non-volatile memories 310, 314, and 318 may each be a different portion of non-volatile memory 118 of FIG. 1.

In one embodiment, each of DIMMs 302, 304, and 306 may be a different circuit board. Furthermore, volatile memories 308, 312, and 316 may each comprise more than one integrated circuit and non-volatile memories 310, 314, and 318 may each comprise more than one integrated circuit. Accordingly, for example, DIMM 302 may include a plurality of volatile memory integrated circuits that make up volatile memory 308 and a plurality of non-volatile memory integrated circuits that make up non-volatile memory 310.

Each of DIMMs 302, 304, and 306 may store different application data. Consequently, when a checkpoint is encountered, checkpoint management module 104 may initiate copying checkpoint data from volatile memory 308 to non-volatile memory 310, from volatile memory 312 to non-volatile memory 314, and from volatile memory 316 to non-volatile memory 318. In one embodiment, checkpoint management module 104 may communicate with DIMMs 302, 304, and 306 using a fully-buffered DIMM control protocol.

In one embodiment, checkpoint management module 104 and/or processing circuitry 102 may communicate with each of DIMMs 302, 304, and 306 individually to initiate copying of checkpoint data from volatile memory 116 to non-volatile memory 118. DIMM 302 may copy data between volatile memory 308 and non-volatile memory 310 independent of DIMMs 304 and 306. In fact, a first portion of the checkpoint data may be copied from volatile memory 308 to non-volatile memory 310 while a second portion of the checkpoint data is being copied from volatile memory 312 to non-volatile memory 314 while a third portion of the checkpoint data is being copied from volatile memory 316 to non-volatile memory 318. Doing so may be significantly faster than waiting to copy the second portion of the checkpoint data until the first portion has been copied and waiting to copy the third portion of the checkpoint data until the second portion has been copied.

A similar approach may be used when restoring checkpoint data from non-volatile memory 118 to volatile memory 116. According to this approach, checkpoint management module 104 and/or processing circuitry 102 may communicate with each of DIMMs 302, 304, and 306 individually in order to initiate copying of checkpoint data from non-volatile memory 118 to volatile memory 116. Simultaneously a first portion of the checkpoint data may be copied from non-volatile memory 310 to volatile memory 308, a second portion of the checkpoint data may be copied from non-volatile memory 314 to volatile memory 312, and a third portion of the checkpoint data may be copied from non-volatile memory 318 to volatile memory 316.

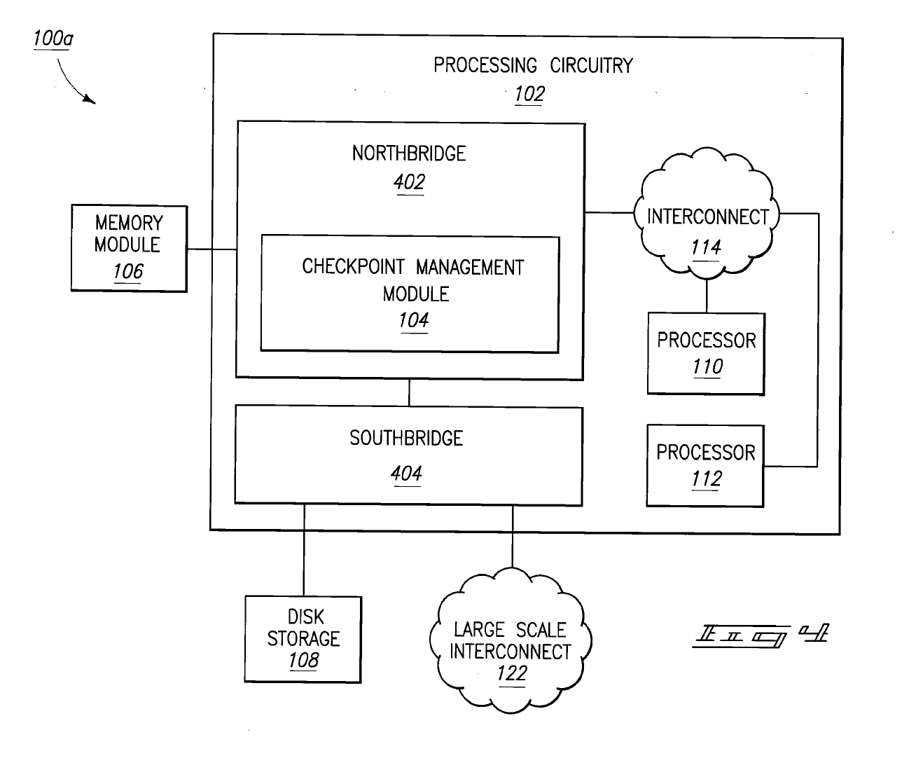

Referring to FIG. 4, an alternative embodiment of processing system 100 is illustrated as system 100a. In this embodiment, processing circuitry 102 includes processors 110 and 112 and interconnect 114, as does the embodiment of processing circuitry 102 illustrated in FIG. 1. In addition, processing circuitry 102 includes a northbridge 402 and a southbridge 404 which may individually include a respective processor.

Northbridge 402 may receive control and/or data transactions from processors 110 and 112 via interconnect 114. For each transaction, northbridge 402 may determine whether the transaction is destined for memory module 106, disk storage 108, or large scale interconnect 122. If the transaction is destined for memory module 106, northbridge 402 may forward the transaction to memory module 106. If the transaction is destined for disk storage 108 or large scale interconnect 122, northbridge 402 may forward the transaction to southbridge 404, which may then forward the transaction to either disk storage 108 or large scale interconnect 122. Southbridge 404 may convert the request into a protocol appropriate for either disk storage 108 or large scale interconnect 122.

In one embodiment, northbridge 402 includes checkpoint management module 104. In this embodiment, checkpoint management module 104 may store instructions that are transferred to processor 110 and/or processor 112 for execution. Alternatively or additionally, northbridge 401 may include control logic that implements all or portions of checkpoint management module 104. Alternatively, in another embodiment, checkpoint management module 104 may be implemented as instructions that are processed by processor 110 and/or processor 112 (e.g., as a concealed hypervisor or firmware).

In contrast to the systems and methods of the disclosure described above, other computer systems that do not include non-volatile memory may copy checkpoint data from volatile memory to disk storage and may retrieve checkpoint data from disk storage to volatile memory in the event of an error. Storing checkpoint data in non-volatile memory rather than in disk storage may provide several advantages over these other computer systems.

In one embodiment, storing checkpoint data to non-volatile memory may be more than an order magnitude faster than storing checkpoint data to disk storage because non-volatile memory may be much faster than disk storage. Furthermore, checkpoint data may be copied between volatile memory and non-volatile memory in parallel.

Storing checkpoint data in non-volatile memory may consume less energy than storing the checkpoint data in disk storage because a physical distance between volatile memory and non-volatile memory may be much smaller than a physical distance between volatile memory and disk storage. This shorter physical distance may also reduce latency. Furthermore, storing checkpoint data in non-volatile memory may consume less energy than storing the checkpoint data in disk storage because in contrast to disk storage, non-volatile memory might not include moving parts.

The availability of a processor system or processor cluster may increase as a result of writing checkpoint data to non-volatile memory instead of writing the checkpoint data to disk storage since an amount of time used to restore a checkpoint from non-volatile memory may be significantly less than an amount of time used to restore a checkpoint from disk storage. Furthermore, storing checkpoint data in non-volatile memory may result in fewer errors than storing the checkpoint data in disk storage because disk storage is subject to mechanical failure modes (due to the use of moving parts) to which non-volatile memory is not subject.

In one embodiment, an availability calculation for a processor system may involve an amount of unplanned downtime of the processor system. Time spent restoring checkpoint data to volatile memory following detection of an error may be considered unplanned downtime. Since restoring checkpoint data to volatile memory from non-volatile memory may be faster than restoring checkpoint data to volatile memory from disk storage, the amount of unplanned downtime when checkpointing to non-volatile memory may be less than the amount of unplanned downtime when checkpointing to disk storage.

One example availability equation for a processor system may be: availability=1/(1+error rate×unplanned downtime). By way of example, if 1000 errors occur per year and the downtime per error when restoring checkpoint data from disk storage is 3 seconds, the availability of the processor system may be greater than 99.99% but less than 99.999% and may therefore be referred to as having “four nines” reliability. In contrast, using non-volatile memory, if the downtime per checkpoint when restoring checkpoint data from non-volatile memory is 300 milliseconds, the availability of the system may be greater than 99.999% but less than 99.9999% and may therefore be referred to as having “five nines” reliability.

In addition to decreasing unplanned downtime of the processor system, writing checkpoint data to non-volatile memory instead of disk storage may also decrease an amount of planned downtime of the processor system. As was discussed above, execution of the application by the processor system may be suspended while the checkpoint data is being written to non-volatile memory. The amount of time the application is suspended may be considered planned downtime of the processor system. Writing the checkpoint data to non-volatile memory may significantly decrease the amount of planned downtime of the processor system as compared to writing the checkpoint data to disk storage since less time is required to write the checkpoint data to non-volatile memory.

The protection sought is not to be limited to the disclosed embodiments, which are given by way of example only, but instead is to be limited only by the scope of the appended claims.

Further, aspects herein have been presented for guidance in construction and/or operation of illustrative embodiments of the disclosure. Applicant(s) hereof consider these described illustrative embodiments to also include, disclose, and describe further inventive aspects in addition to those explicitly disclosed. For example, the additional inventive aspects may include less, more and/or alternative features than those described in the illustrative embodiments. In more specific examples, Applicants consider the disclosure to include, disclose and describe methods which include less, more and/or alternative steps than those methods explicitly disclosed as well as apparatus which includes less, more and/or alternative structure than the explicitly disclosed structure.

1. A data storage method comprising:
executing an application using processing circuitry;
during the executing, writing data generated by the executing of the application to volatile memory;
after the writing, providing an indication of a checkpoint;
after the providing, copying the data from the volatile memory to non-volatile memory;
suspending the executing of the application during the copying; and
after the copying, continuing the executing of the application.

2. (canceled)

3. The method of claim 2 further comprising:
subsequent to the continuing of the execution, detecting an error in the executing of the application;
responsive to the detecting, copying the data from the non-volatile memory to the volatile memory; and
after the copying of the data from the non-volatile memory to the volatile memory, executing the application from the checkpoint using the copied data stored in the volatile memory.

4. The method of claim 1 wherein the non-volatile memory comprises solid-state memory.

5. The method of claim 1 wherein the non-volatile memory comprises random-access memory.

6. The method of claim 1 wherein the non-volatile memory comprises a plurality of integrated circuit chips and the copying of the data comprises simultaneously copying a first subset of the data to a first one of the plurality of integrated circuit chips and copying a second subset of the data to a second one of the plurality of integrated circuit chips.

7. (canceled)

8. The method of claim 1 wherein the providing comprises providing the indication using an operating system executed by the processing circuitry.

9. A data storage method comprising:
receiving an indication of a checkpoint associated with execution of one or more applications;
as a result of the receiving, suspending the execution of the one or more applications; and
as a result of the receiving and using a checkpoint management module, copying data resulting from the execution of the one or more applications from volatile memory coupled to the checkpoint management module to non-volatile memory coupled to the checkpoint management module.

10. The method of claim 9 wherein the receiving comprises receiving from processing circuitry and the method further comprises determining that the data has been copied to the non-volatile memory and notifying the processing circuitry that the data has been copied to the non-volatile memory.

11. The method of claim 9 wherein the non-volatile memory is non-volatile solid-state memory and the non-volatile solid-state memory and the volatile memory are both part of a single dual inline memory module (DIMM).

12. The method of claim 9 wherein the indication describes locations within the volatile memory where the data is stored.

13. The method of claim 9 wherein a first DIMM comprises a first portion of the non-volatile memory and a first portion of the volatile memory and a second DIMM comprises a second portion of the non-volatile memory and a second portion of the volatile memory and the copying comprises first copying from the first portion of the volatile memory to the first portion of the non-volatile memory and second copying from the second portion of the volatile memory to the second portion of the non-volatile memory.

14. A computer system comprising:
processing circuitry configured to process instructions of an application;
a checkpoint management module;
volatile memory configured to store data generated by the processing circuitry during the processing of the instructions of the application;
non-volatile memory configured to receive the data from the volatile memory and to store the data; and
wherein the processing circuitry is configured to suspend processing of the application and the checkpoint management module is configured to copy the data from the volatile memory to the non-volatile memory as a result of a checkpoint being indicated.

15. (canceled)

16. The system of claim 14 wherein the checkpoint management module is configured to simultaneously copy different portions of the data to the non-volatile memory in parallel.

17. (canceled)

18. (canceled)

19. The system of claim 14 wherein:
the volatile memory comprises a plurality of integrated circuit chips, each integrated circuit chip of the plurality storing a different portion of the data; and
the checkpoint management module is configured to simultaneously copy the portions of the data from the plurality of integrated circuit chips to the non-volatile memory.

20. The system of claim 14 further comprising:
a plurality of DIMMs, each DIMM comprising a different portion of the volatile memory and a different portion of the non-volatile memory; and
individual DIMMs of the plurality are configured to copy data stored in the non-volatile memory portion of the individual DIMM to the volatile memory portion of the individual DIMM independent of the other DIMMs of the plurality.

21. The system of claim 14 further comprising a memory module comprising at least a portion of the volatile memory and at least a portion of the non-volatile memory.

22. The system of claim 14 wherein the checkpoint is a first checkpoint, the data is first data, and the checkpoint management module is configured to, as a result of a second checkpoint being indicated after the first checkpoint, copy second data generated by the processing circuitry during processing of the instructions of the application from the volatile memory to the non-volatile memory without displacing the first data from the non-volatile memory.

23. The system of claim 14 further comprising:
a first memory module coupled to the checkpoint management module, the first memory module comprising at least a portion of the volatile memory; and
a second memory module coupled to the checkpoint management module, the second memory module comprising at least a portion of the non-volatile memory.

24. The system of claim 14 wherein the copying of the data from the volatile memory to the non-volatile memory is faster compared with copying the data from the volatile memory to disk storage, and the non-volatile memory is void of disk storage.

25. The system of claim 14 wherein the volatile memory stores the data at a plurality of initial moments of time and the checkpoint management module is configured to copy the data which was stored in the volatile memory at the initial moments in time only after the checkpoint is indicated at another moment in time after all of the initial moments in time.
